(19) United States
(12) Patent Application Publication
(10) Pub. No.: US 2025/0210221 A1
(43) Pub. Date: Jun. 26, 2025

(54) WIRE HARNESS ASSEMBLY

(71) Applicant: Yazaki Corporation, Tokyo (JP)

(72) Inventors: Ryo HAMADA, Shizuoka (JP); Yukio Nishio, Shizuoka (JP)

(73) Assignee: Yazaki Corporation, Tokyo (JP)

(21) Appl. No.: 18/976,496

(22) Filed: Dec. 11, 2024

(30) Foreign Application Priority Data
Dec. 20, 2023 (JP) 2023-214999

(51) Int. Cl. H01B 7/00

(52) U.S. Cl. CPC H01B 7/0045

(57) ABSTRACT

A wire harness assembly includes: a wire harness including an electric wire and a connector electrically connected to an end of the electric wire; and a soundproofing member including a base and a cover integrally provided on one surface side of the base with the wire harness being arranged between the base and the cover. At least one of the base or the cover includes through holes. The through holes are arranged to be distributed to opening regions. The opening regions are different from each other in opening ratios per unit area of the through holes in the opening regions.

### CROSS-REFERENCE TO RELATED APPLICATIONS

The present application is based on and claims the benefit of priority from the prior Japanese Patent Application No. 2023-214999, filed on Dec. 20, 2023, the entire contents of which are incorporated by reference herein.

### TECHNICAL FIELD

The disclosure relates to a wire harness assembly.

### BACKGROUND

JP 2015-67085 A describes a wire harness assembly that includes a wire harness including an electric wire and a connector electrically connected to an end of the electric wire. The wire harness assembly includes a porous body as a base and a sheet-shaped body as a cover integrally provided on one surface side of the porous body. A soundproofing member in which the wire harness is arranged is provided between the porous body and the sheet-shaped body. In the wire harness assembly, a plurality of through holes are provided in the sheet-shaped body. By providing the plurality of through holes in the sheet-shaped body, a sound can be absorbed in a wider frequency range as compared with a sheet-shaped body having no through holes, and soundproofing properties can be improved.

### SUMMARY

In the wire harness assembly described above, the plurality of through holes are uniformly provided over an entire surface of the soundproofing member. In a case where the plurality of through holes are uniformly provided, the frequency range in which a sound can be absorbed is the same at any position of the soundproofing member. For this reason, in the soundproofing member of the wire harness assembly described above, there is a limit to a frequency range in which a sound can be absorbed.

The disclosure is directed to a wire harness assembly having improved soundproofing properties.

A wire harness assembly in accordance with some embodiments includes: a wire harness including an electric wire and a connector electrically connected to an end of the electric wire; and a soundproofing member including a base and a cover integrally provided on one surface side of the base with the wire harness being arranged between the base and the cover. At least one of the base or the cover includes through holes. The through holes are arranged to be distributed to opening regions. The opening regions are different from each other in opening ratios per unit area of the through holes in the opening regions.

According to the above-described configuration, the soundproofing properties of the wire harness assembly can be improved.

### BRIEF DESCRIPTION OF THE DRAWINGS

FIG. 1 is a perspective view of a wire harness assembly according to an embodiment.

FIG. 2 is an exploded perspective view of the wire harness assembly according to the present embodiment.

FIG. 3 is a top view of a cover of the wire harness assembly according to the present embodiment.

### DETAILED DESCRIPTION

Hereinafter, a wire harness assembly 1 according to an embodiment will be described in detail with reference to the drawings. Note that dimensional ratios in the drawings are exaggerated for convenience of explanation, and may be different from actual ratios.

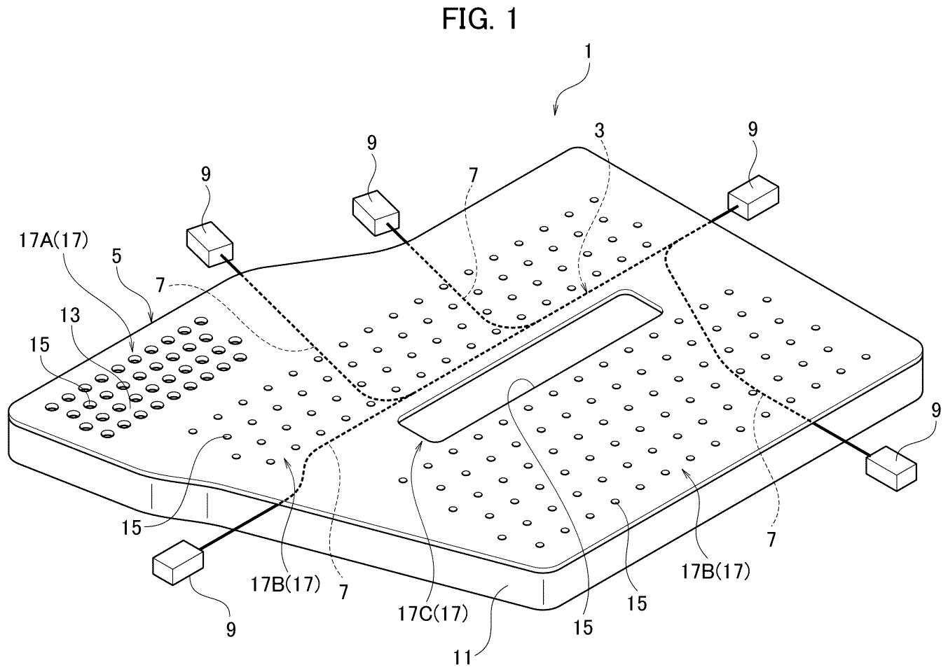

As illustrated in FIG. 1, the wire harness assembly 1 according to the present embodiment is applied to, for example, a wire harness 3 that electrically connects electrical components (not illustrated), e.g., a power supply mounted on a vehicle and a device or a device and a device. The wire harness 3 is arranged in a predetermined shape inside a soundproofing member 5 integrally assembled therewith. The wire harness assembly 1 is assembled to a target member (not illustrated), e.g., a door trim of a vehicle. The soundproofing member 5 assembled to the target member absorbs, for example, a sound propagating from the outside to the vehicle interior to maintain quietness in the vehicle interior.

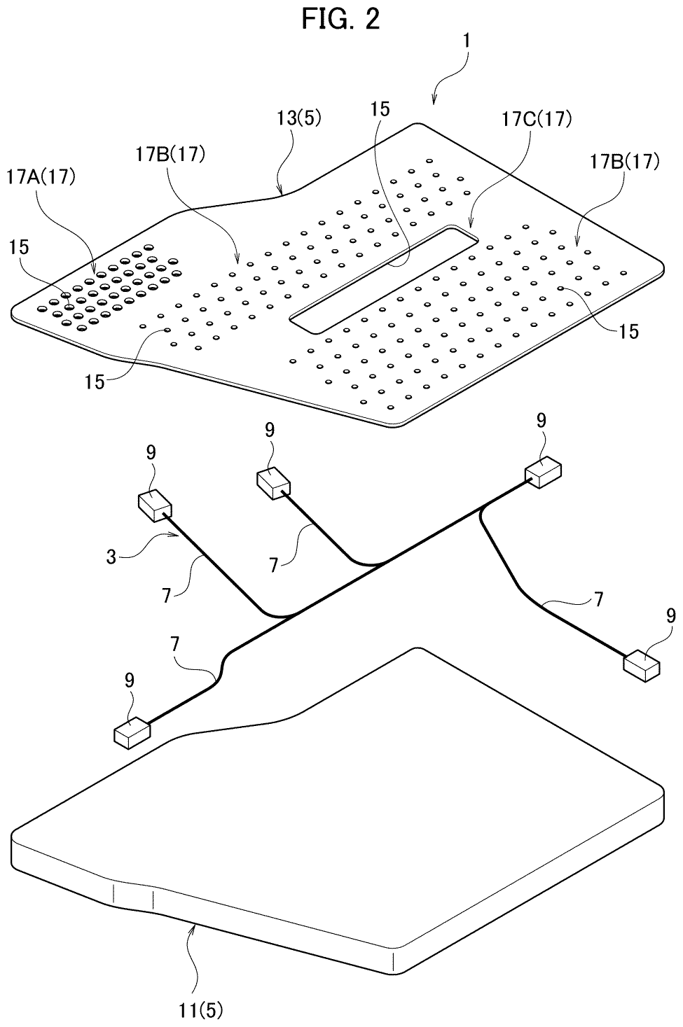

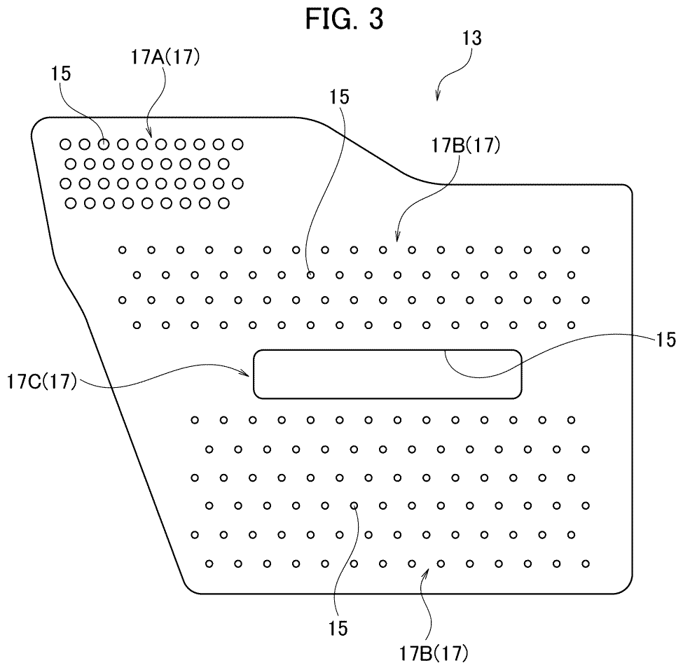

As illustrated in FIGS. 1 to 3, the wire harness assembly 1 includes a wire harness 3 and a soundproofing member 5.

As illustrated in FIGS. 1 to 3, the wire harness 3 includes an electric wire 7 and a connector 9.

The electric wire 7 includes, for example, a sheathed electric wire in which an outer periphery of a core wire made of a conductive material is sheathed with an insulating sheath, and a plurality of (four in the present embodiment) electric wires 7 are used. The electric wire 7 may be a flat cable in which outer peripheries of a plurality of core wires are sheathed with an insulating sheath in a state where the plurality of core wires are arranged in parallel. The plurality of electric wires 7 are arranged in such a manner that ends on both sides thereof are exposed from the soundproofing member 5. The plurality of electric wires 7 are arranged in such a manner that the ends on one end sides are collected at one location, and the ends on the other end sides are branched.

The connector 9 includes, for example, a housing (not illustrated) made of an insulating material such as a synthetic resin, and a terminal (not illustrated) made of a conductive material. The housing can be fitted to, for example, a mating housing (not illustrated) of a mating connector (not illustrated) electrically connected to an electric component mounted on the vehicle. The terminal is electrically connected to the end of the electric wire 7, and is accommodated in the housing. The terminal is electrically connected to a mating terminal (not illustrated) accommodated in the mating housing by fitting the housing to the mating housing. A plurality of (five in the present embodiment) connectors 9 are used to correspond to the ends of the plurality of electric wires 7 exposed from the soundproofing member 5.

As illustrated in FIGS. 1 to 3, the soundproofing member 5 includes a base 11 and a cover 13.

The base 11 is made of, for example, a foam of urethane or the like, or a nonwoven fabric of polypropylene fibers, polyethylene terephthalate fibers, polyester-based fibers, or the like, and has soundproofing and heat insulating properties. The base 11 is formed in a sheet shape with a size set so that the base 11 is arranged within the range of the target member, and is assembled to the target member by a fixing means (not illustrated) such as press fitting. On one surface side of the base 11, the plurality of (four in the present embodiment) electric wires 7 of the wire harness 3 are arranged in a predetermined shape. The ends of the plurality of electric wires 7, each of the electric wires 7 being arranged on the base 11, are exposed from an outer edge of the base 11 with a predetermined length, and the connectors 9 are arranged outside the base 11.

The cover 13 is made of, for example, a film of vinyl chloride, polyethylene, or the like, or a closed-cell foam or an open-cell foam of polyethylene, polypropylene, polystyrene, elastomer, or the like, and has soundproofing and heat insulating properties. The cover 13 is formed in a sheet shape with a size set to be equal to that of the base 11 so that the cover 13 is arranged within the range of the target member, and a thickness set to be smaller than that of the base 11. An adhesive is applied onto a surface of the cover 13 facing the base 11, and the cover 13 is attached to one surface side of the base 11 in such a manner that the plurality of electric wires 7 are sandwiched between the cover 13 and the base 11. In a state where the cover 13 is integrally attached to the base 11, the plurality of electric wires 7 arranged in a predetermined shape are held between the base 11 and the cover 13. Therefore, the soundproofing member 5 can protect the electric wire 7 of the wire harness 3, and maintain the arrangement shape of the electric wire 7.

The connector 9 exposed from the soundproofing member 5 is fitted to a mating connector in a state where the wire harness assembly 1 is assembled to the target member. At this time, since the electric wire 7 is exposed from the outer edge of the soundproofing member 5 with a predetermined length, the connector 9 can freely move, making it easy to fit the connector 9 to a mating connector. By fitting the connector 9 to the mating connector, electrical components are electrically connected to each other.

In the soundproofing member 5 of the wire harness assembly 1, the cover 13 has a plurality of through holes 15. By providing the plurality of through holes 15 in the cover 13, a sound can be absorbed in a wider frequency range as compared with a cover 13 having no through holes 15, and soundproofing properties can be improved. It is known that in a case where the opening areas of the plurality of through holes 15 are small with respect to the entire area on one surface side of the soundproofing member 5, the sound absorbing properties in the low frequency range is enhanced, and in a case where the opening areas of the plurality of through holes 15 are large with respect to the entire area on one surface side of the soundproofing member 5, the sound absorbing properties in the high frequency range is enhanced. Therefore, desired soundproofing properties can be obtained by setting the opening areas of the plurality of through holes 15 in accordance with the target frequency range.

Here, in a conventional wire harness assembly, a plurality of through holes are provided in the same shape over an entire surface on one surface side of a soundproofing member, and intervals between adjacent through holes are set to be equal. Therefore, in the conventional wire harness assembly, the plurality of through holes form an opening region with a uniform opening ratio per unit area in any portion of the soundproofing member. Here, the opening ratio per unit area is a ratio indicating how much the opening areas of the through holes occupy with respect to a predetermined area. That is, the opening ratio per unit area can be obtained by dividing the sum of the opening areas of the through holes arranged in the predetermined range by the area of the predetermined range. In such a conventional wire harness assembly, the frequency range in which a sound can be absorbed is the same in any portion of the soundproofing member, and there is a limit to the frequency range in which a sound can be absorbed.

On the other hand, the wire harness assembly 1 according to the present embodiment includes a plurality of opening regions 17 where the plurality of through holes 15 are different in opening ratio per unit area. In the following description, it is assumed that the plurality of through holes 15 are provided in the cover 13, but the plurality of through holes 15 may be provided in the base 11.

As illustrated in FIGS. 1 to 3, the plurality of through holes 15 are arranged in the plurality of opening regions 17 in a distributed manner over the entire surface of the cover 13, and the plurality of opening regions 17 are different from each other in opening ratios per unit area of the through holes 15 in the plurality of opening regions 17. In the present embodiment, the plurality of through holes 15 are arranged in a distributed manner, for example, in an opening region 17A, an opening region 17B, and an opening region 17C. In the opening region 17A, a plurality of circular through holes 15 having a larger diameter than the through holes 15 in the opening region 17B are provided, and an interval between adjacent through holes 15 is set to be smaller than that between adjacent through holes 15 in the opening region 17B. In the opening region 17B, a plurality of circular through holes 15 having a smaller diameter than the through holes 15 in the opening region 17A are provided, and an interval between adjacent through holes 15 is set to be larger than that between adjacent through holes 15 in the opening region 17A. In the opening region 17C, one through hole 15 having a rectangular shape is provided.

In the present embodiment, the opening region 17C has the highest opening ratio per unit area. The opening region 17A has the second highest opening ratio per unit area. The opening region 17B has the lowest opening ratio per unit area. Therefore, in each opening region 17, a frequency range in which a sound can be absorbed is different. In the soundproofing member 5 having the plurality of opening regions 17, sounds in different frequency ranges can be absorbed in portions where the plurality of opening regions 17 are located, and the frequency range in which a sound can be absorbed is wide. Therefore, a sound can be absorbed in a wide frequency range by the soundproofing member 5, and soundproofing properties can be improved. Furthermore, since the shapes of the through holes 15 and the intervals between adjacent through holes 15 are different between the plurality of opening regions 17, the plurality of opening regions 17 can be different in opening ratio per unit area with a simple structure.

The electric wire 7 of the wire harness 3 arranged inside the soundproofing member 5 may be arranged to avoid the plurality of through holes 15. By arranging the electric wire 7 to avoid the plurality of through holes 15, the electric wire 7 is not exposed from the soundproofing member 5, and the electric wire 7 can be stably protected by the soundproofing member 5.

The wire harness assembly 1 according to the present embodiment includes a wire harness 3 including an electric wire 7 and a connector 9 electrically connected to an end of the electric wire 7. The wire harness assembly 1 also includes a soundproofing member 5 including a base 11 and a cover 13 integrally provided on one surface side of the base 11, with the wire harness 3 being arranged between the base 11 and the cover 13. At least one of the base 11 or the cover 13 includes a plurality of through holes 15. The plurality of through holes 15 are arranged in a distributed manner in a plurality of opening regions 17. The plurality of opening regions 17 are different from each other in opening ratios per unit area of the through holes 15 in the plurality of opening regions 17.

In the soundproofing member 5 having the plurality of through holes 15 in the plurality of opening regions 17, sounds in different frequency ranges can be absorbed in portions where the plurality of opening regions 17 are located, and the frequency range in which a sound can be absorbed is wide. Therefore, a sound can be absorbed in a wide frequency range by the soundproofing member 5, and soundproofing properties can be improved.

Therefore, in the wire harness assembly 1, soundproofing properties can be improved.

The plurality of opening regions 17 are different from each other in at least one of shapes of the through holes 15 or intervals between adjacent ones of the through holes 15.

Therefore, the plurality of opening regions 17 can be different in opening ratio per unit area with a simple structure.

In the above-described embodiment, the through holes 15 have a perfect circular shape or a quadrangular shape, but the present invention is not limited thereto. For example, the through holes 15 may have any shape such as an elliptical shape or a polygonal shape such as a triangular shape. For example, in a case where the through holes 15 have a quadrangular shape, the opening ratio per unit area can be higher than that in a case where the through holes 15 have a perfect circular shape and intervals between adjacent through holes 15 are set to be equal.

The plurality of opening regions 17 are provided at three locations in the soundproofing member 5, but the present invention is not limited thereto, and the plurality of opening regions 17 may be provided at two locations or four or more locations in the soundproofing member 5.

The plurality of through holes 15 are provided in the cover 13, but the present invention is not limited thereto, and the plurality of through holes 15 may be provided in the base 11. In this case, it is not required to provide a plurality of through holes 15 in the cover 13, but the through holes 15 may be provided in the cover 13 to adjust a frequency range in which a sound can be absorbed. In addition, the thicknesses and the like of the cover 13 and the base 11 may be adjusted in accordance with the frequency range in which a sound is absorbed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wire harness assembly comprising:
a wire harness including an electric wire and a connector electrically connected to an end of the electric wire; and
a soundproofing member including a base and a cover integrally provided on one surface side of the base with the wire harness being arranged between the base and the cover, wherein
at least one of the base or the cover includes through holes,
the through holes are arranged to be distributed to opening regions, and
the opening regions are different from each other in opening ratios per unit area of the through holes in the opening regions.

2. The wire harness assembly according to claim 1, wherein the opening regions are different from each other in at least one of shapes of the through holes or intervals between adjacent ones of the through holes.
